(19) United States
(12) Patent Application Publication
(10) Pub. No.: US 2003/0163816 A1
(43) Pub. Date: Aug. 28, 2003

(54) Use of transcript information to find key audio/video segments

(75) Inventors: Srinivas Gutta, Yorktown Heights, NY (US); Lalitha Agnihotri, Fishkill, NY (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/086,046

(22) Filed: Feb. 28, 2002

(51) Int. Cl. H04N 5/445; H04N 7/16

(52) U.S. Cl. 725/46; 725/135; 725/151

(57) ABSTRACT

Disclosed is a method and system for detecting a particular content in a stream of video data signals preferred by a user. Accordingly, the present invention obtains a user's profile or monitors a user's viewing history of various programs to determine the type of program content that is not watched or not liked by the user. Thereafter, incoming television programs are compared with the user's profile or the user's past viewing information to determine whether some portion of the incoming television programs are liked by the user. The portion of the program content liked by the user is collectively stored in a storage medium, then the user can subsequently view only the segments of the programs preferred by the user.

### BACKGROUND OF THE INVENTION

1. Field of the Invention

The present invention relates to the detection of a particular content in a stream of video data signals, and more particularly to a system and method for compiling a number of key audio/video segments of interest to a television viewer according to his or her criteria.

2. Description of the Invention

Both ReplayTV (trademark of REPLAY NETWORKS, INC., of Palo Alto, Calif.) and TiVo (trademark of TIVO, Inc., of Sunnyvale, Calif.) are the first wave of a new type of “VCR” that gives the television viewer new abilities to capture and manipulate the stream of television shows, which flow from their cable and satellite systems. These personal television devices act as a personal assistant by changing channels for viewers, recording programs that interest the viewers, and assisting the viewers to watch recorded programs without commercials when they wish.

As such, the present invention proposes a new mechanism for delivering a summary of video and/or audio content to the viewers by automatically detecting and storing the content of interest for subsequent retrieval.

### SUMMARY OF THE INVENTION

The present invention provides a method and system for delivering the key audio/video segments according to predetermined data representative of content liked by a user or a user's past commercial viewing history.

According to one aspect of the invention, a method of detecting a particular content in a stream of video data signals according to a user's criteria is provided. The method includes the steps of: obtaining a user profile indicating video content preferred by the user; comparing incoming television programs in a channel to the user profile to detect at least one key frame preferred by the user; storing the key frame preferred by the user in a storage means for subsequent retrieval; and, retrieving the key frame stored in the storage means for display, wherein the user profile is interactively created in advance. The method further includes the step of converting the video signals of the incoming television programs into a time-based map of transcript data and storing a plurality of key words liked by the user in the user profile.

Another aspect of the invention provides a method of detecting a particular content in a stream of video data signals according to a user's criteria. The method includes the steps of: obtaining a user profile indicating the video content preferred by the user; analyzing incoming television programs to detect a plurality of key frames liked by the user based on the user profile; identifying the beginning and ending positions of each of the plurality of key frames; and, storing the plurality of key frames liked by the user in a storage means for subsequent retrieval. The method further includes the steps of retrieving the plurality of key frames stored in the storage means; storing a plurality of key words liked by the user in the user profile; and, displaying the identified beginning and ending position of each of the plurality of key frames. The analyzing step further includes the steps of: detecting the frequency of key words appearing within a predetermined time period; comparing the detected frequency to a threshold value; and, identifying the beginning and ending positions of each of the plurality of the key frames if the detected frequency exceeds a threshold value. The user profile also may be obtained according to a viewing history of the user.

According to another aspect of the invention, a system of detecting a particular content in a stream of video data signals according to a user's criteria is provided. The system includes a memory for storing a computer-readable code; and, a processor operatively coupled to the memory, the processor configured to: obtain a user profile indicating the video content preferred by the user; compare incoming television programs in a channel to the user profile to detect at least one key frame preferred by the user; and, store the key frame preferred by the user in a storage means for subsequent retrieval. The processor is further operative to retrieve the key frame stored in the storage means for display and convert the video signals of the incoming television programs into a time-based map of transcript data.

According to a further aspect of the invention, a system of detecting a particular content in a stream of video data signals according to a user's criteria is provided. The system includes a first storage means for storing a plurality of key words liked by the user; a detection means, coupled to receive incoming television programs, for detecting a plurality of key frames preferred by the user; a second storage means for storing the plurality of key frames preferred by the user; a controlling means, coupled to the first storage means, the detection means, and the second storage means for determining the plurality of key frames preferred by the user based on a comparison between the received incoming television programs and the data stored in the first storage means; and, a replay means coupled to the controlling means for replaying the plurality of key frames from the second storage means for viewing. The system further includes a converting means for converting the incoming television programs into a time-based map of transcript data, and a display means for displaying the output signals of the replaying means.

These and other advantages will become apparent to those skilled in this art upon reading the following detailed description in conjunction with the accompanying drawings.

### BRIEF DESCRIPTION OF THE DRAWINGS

FIG. 1 shows a block diagram of a hardware system whereto the embodiment of the present invention may be applied;

FIG. 2 illustrates a simplified block diagram of the system according to an embodiment of the present invention; and,

FIG. 3 is a flow chart illustrating the operation process according to an embodiment of the present invention.

### DETAILED DESCRIPTION OF THE EMBODIMENTS

In the following description, for purposes of explanation rather than limitation, specific details are set forth such as the particular architecture, interfaces, techniques, etc., in order to provide a thorough understanding of the present invention. However, it will be apparent to those skilled in the art that the present invention may be practiced in other embodiments that depart from these specific details. For the purpose of simplicity and clarity, detailed descriptions of well-known devices, circuits, and methods are omitted so as not to obscure the description of the present invention with unnecessary detail.

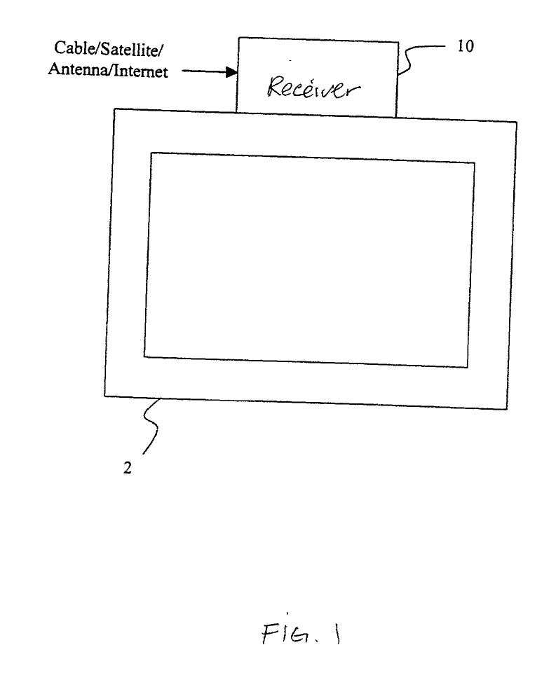

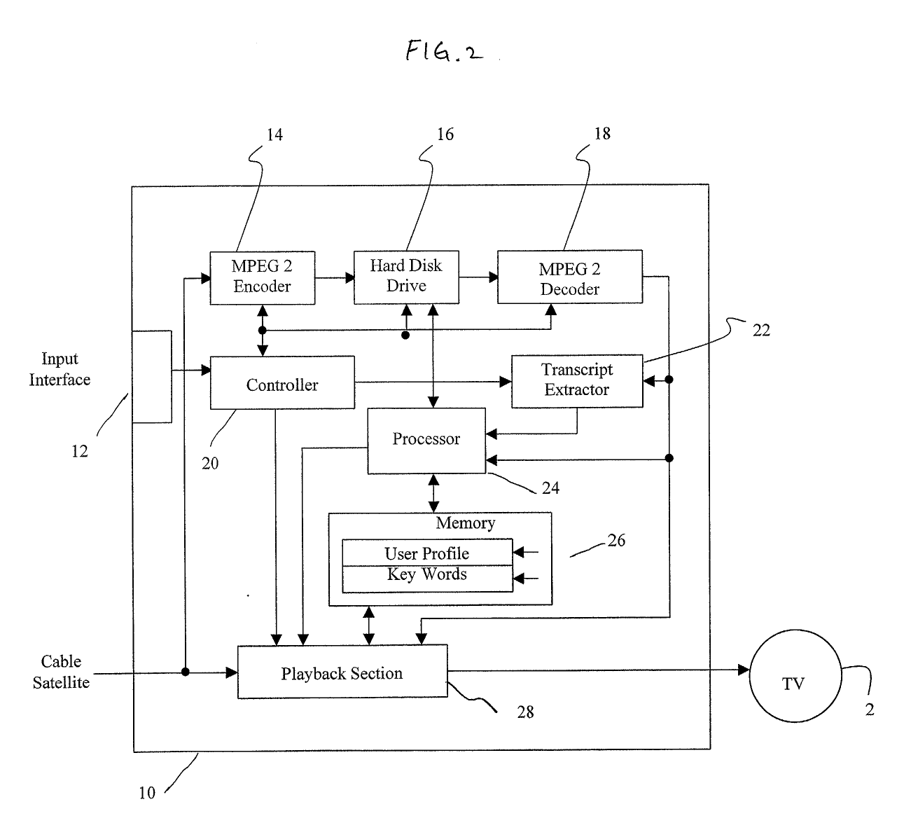

FIG. 1 shows a block diagram of a hardware system whereto the embodiment of the present invention may be applied. As shown in FIG. 1, the apparatus 10 is adapted to receive a stream of video signals from a variety of sources, including a cable service provider, a digital high definition television (HDTV) and/or digital standard definition television (SDTV) signals, a satellite dish, a conventional RF broadcast, an Internet connection, or another storage device, such as a VHS player or DVD player. The audio/video programming along with the data signals can be delivered in analog, digital, or digitally compressed formats via any transmission means, including satellite, cable, wire, television broadcast, or sent via the Web. The Internet connection can be via a high-speed line, RF, conventional modem, or by way of a two-way cable carrying the video programming. It should be noted that the present system is capable of being connected to other possible networks, such as a direct private network and a wireless network. According to the embodiment of the present invention, the apparatus 10 processes and generates data that is representative of a plurality of program segments that is of interest to a given user. The major components of the apparatus 10 is shown in FIG. 2, and described below.

FIG. 2 illustrates an exemplary apparatus 10 in greater detail according to the embodiment of the present invention. The apparatus 10 includes an input interface (i.e., IR sensor) 12, an MPEG-2 encoder 14, a hard disk drive 16, an MPEG-2 decoder 18, a controller 20, a transcript detector 22, a video processor 24, a memory 26, and a playback section 28. It should be noted that an MPEG encoder/decoder can comply with other MPEG standards, i.e., MPEG-1, MPEG-2, and MPEG-4. The controller 20 oversees the overall operation of the detection system 10, including a detection mode, record mode, play mode, and other modes that are common in a video recorder/player.

During a normal viewing mode, the controller 20 causes the incoming television signals to be demodulated and processed by the video processor 24 and transmits them to the television set 2. The video processor 24 converts the incoming TV signals to corresponding baseband television signals suitable for display on the television set 2. Here, the incoming TV signals are not stored or retrieved from the hard disk driver 16.

During a normal recording mode, the controller 20 causes the MPEG-2 encoder 14 to receive incoming television signals delivered from satellite, cable, wire, and television broadcasts, or the web, and converts the received TV signals to the MPEG format for storage on the hard disk driver 16. Thereafter, the controller 20 causes the hard disk driver 16 to stream the stored television signals to the MPEG-2 decoder, which in turn transmits the decoded TV signals to be transmitted to the television set 2 via the playback section 28 during a normal playing mode. At the same time, the controller 20 causes the transcript extractor 22 to extract transcripts from either the closed captioning data present in the incoming broadcast video stream. It should be noted that not all commercials are closed-captioned. In such a case, the incoming video programs are converted to generate transcripts using a speech-to-text converter that is well known in the art. Alternatively, the transcripts can be obtained from a well-known OCR(on-screen converting text) operation on the texts shown in the video stream. It should be noted that extracting transcript is well known in the art that can be performed in a variety of ways. The function of transcript extractor 22 is to detect the beginning and ending of key audio/video segments, comprised of a plurality of frames, containing the program segments or frames that are of interest to the user. Once the transcripts corresponding to the content of the user's interest is obtained, the video processor 24 processes a stream of video signals to retrieve the corresponding program segments or frames of interest, and stores them in the memory 26 for subsequent retrieval. Alternatively, the video processor 24 can mark the beginning and ending of the program segments of interest, so that these marked commercial segments can be played at a later stage. Finally, upon receiving a request to preview the recorded program segments of interest, the program content stored in the memory 26 is forwarded to the television set 2 for display via the play back section 28.

To generate a database for the user profile of memory 26, a suitable interface exists between the user and the apparatus 10 to gather the user's hot and cold lists for the type of program content he or she wishes to see or skip. For example, if the user wants to receive information relating to a particular actor or actress, the user can give the name of that actor or actress as a query in the user profile. Similarly, the user can specify other types of TV program contents by listing a plurality of key words associated with the program content in the user profile. Alternatively, the inventive system 10 can build the viewing history of a given user to determine the type of program contents preferred by the user, by observing the user's commercial viewing habits over time and generalizing the user's viewing habits to build a database that is similar to the user profile. Obtaining the user profile based on the viewing history of the user can be performed in a variety of ways. An example of such a system, which employs decision trees, is described in a patent application, PCT WO 01/45408 (Gutta), assigned to the same assignee, and herein incorporated by simple reference. Thus, based on the user's viewing pattern, a database reflecting the user's likes or dislikes of various program contents can be obtained.

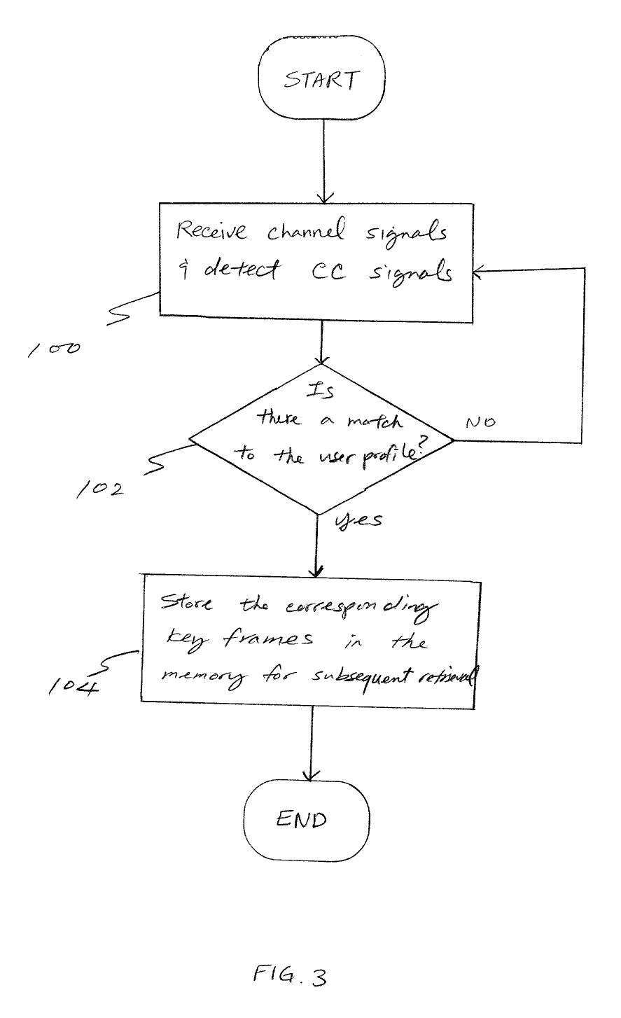

FIG. 3 is a flow chart illustrating the operation steps for detecting key audio/video segments or frames using the configuration shown in FIG. 2. It will be appreciated by those of ordinary skill in the art that unless otherwise indicated herein, the particular sequence of steps described is illustrative only and can be varied without departing from the spirit of the invention. In addition, the flow diagrams illustrate the functional information that one of ordinary skill in the art requires to fabricate circuits or to generate computer software to perform the processing required of the particular apparatus.

The initial set-up of detecting the segments of a program may be triggered by an auto set-up routine, which detects incoming channel signals and identifies the corresponding transcripts, for example, closed-caption (CC) texts in step 100. The detected transcript texts are used to compare with the pre-recorded key words in query format that is stored in the user profile. Here, the controller 20 causes the transcript extractor 22 to count the frequency of the occurrence of the “non-stop” (words other than “an”, “the”, “of”, etc.) words that occur within a series of predetermined time period. If one or more key words occur more than twice within each predetermined time interval, then the corresponding key audio/video segment or frames is determined to be a possible content of interest to the user in step 102. The detected frequency of the key words is then compared to a predetermined threshold value of, for example, 2. If the detected frequency of the key words exceeds the threshold value, the program segment or frames containing the key words is stored in the memory for subsequent retrieval in step 104.

While the preferred embodiments of the present invention have been illustrated and described, it will be understood by those skilled in the art that various changes and modifications may be made, and equivalents may be substituted for elements thereof without departing from the true scope of the present invention. In addition, many modifications may be made to adapt to a particular situation and the teaching of the present invention without departing from the central scope. Therefore, it is intended that the present invention not be limited to the particular embodiment disclosed as the best mode contemplated for carrying out the present invention, but that the present invention is intended to include all embodiments falling within the scope of the appended claims.

What is claimed:

1. A method for detecting a particular content in a stream of video data signals according to a user's criteria, the method comprising the steps of:
obtaining a user profile indicating video content preferred by said user;
comparing incoming television programs in a channel to said user profile to detect at least one key frame preferred by said user; and,
storing said key frame preferred by said user in a storage means for subsequent retrieval.

2. The method of claim 1, further comprising the step of retrieving said key frame stored in said storage means for display.

3. The method of claim 1, wherein said comparison step further comprising the step of converting the video signals of said incoming television programs into a time-based map of closed captioning data.

4. The method of claim 1, further comprising the step of storing a plurality of key words liked by said user in said user profile.

5. The method of claim 1, wherein said user profile obtaining step further comprises the step of interactively creating said user profile in advance of said comparison step.

6. The method of claim 1, wherein said user profile is obtained according to a viewing history of said user.

7. A method for detecting a particular content in a stream of video data signals according to a user's criteria, the method comprising the steps of:
obtaining a user profile indicating video content preferred by said user;
analyzing incoming television programs to detect a plurality of key frames liked by said user based on said user profile;
identifying the beginning and ending positions of each of the plurality of said key frames; and,
storing the plurality of said key frames liked by said user in a storage means for subsequent retrieval.

8. The method of claim 7, further comprising the steps of retrieving the plurality of said key frames stored in said storage means; and,
displaying said identified beginning and ending position of each of the plurality of said key frames.

9. The method of claim 7, wherein said analysis step comprises the step of comparing said detected commercial to said user profile to detect the plurality of said key frames liked by said user.

10. The method of claim 7, wherein said analyzing step further includes the steps of:
detecting the frequency of key words appearing within a predetermined time period;
comparing said detected frequency to a threshold value; and,
identifying the beginning and ending positions of each of the plurality of said key frames if said detected frequency exceeds a threshold value.

11. The method of claim 7, further comprising the step of converting the video signals of said incoming television programs into a time-based map of closed captioning data.

12. The method of claim 7, further comprising the step of storing a plurality of key words liked by said user in said user profile.

13. The method of claim 1, wherein said user profile obtaining step further comprises the step of interactively creating said user profile in advance of said comparison step.

14. The method of claim 7, wherein said user profile is obtained according to a viewing history of said user.

15. A system for detecting a particular content in a stream of video data signals according to a user's criteria, comprising:
a memory for storing a computer-readable code; and,
a processor operatively coupled to said memory, said processor configured to:
obtain a user profile indicating video content preferred by said user;
compare incoming television programs in a channel to said user profile to detect at least one key frame preferred by said user; and,
store said key frame preferred by said user in a storage means for subsequent retrieval.

16. The system of claim 15, wherein said processor is further operative to retrieve said key frame stored in said storage means for display.

17. The system of claim 15, wherein said processor is further operative to convert the video signals of said incoming television programs into a time-based map of closed captioning data.

18. The system of claim 15, wherein said user profile contains a plurality of key words liked by said user.

19. The system of claim 15, wherein said user profile is interactively created in advance.

20. A system for detecting a particular content in a stream of video data signals according to a user's criteria, comprising:
a first storage means for storing a plurality of key words liked by said user;
a detection means, coupled to receive incoming television programs, for detecting a plurality of key frames preferred by said user;
a second storage means for storing the plurality of said key frames preferred by said user;
a controlling means, coupled to said first storage means, said detection means, said second storage means for determining the plurality of said key frames preferred by said user based on a comparison between said received incoming television programs and the data stored in said first storage means; and,
a replay means coupled to said controlling means for replaying the plurality of said key frames from said second storage means for viewing.

21. The system of claim 20, further comprising a converting means for converting said incoming television programs into a time-based map of closed captioning data.

22. The system of claim 20, further comprising a display means for displaying the output signals of said replaying means.

23. The system of claim 15, wherein the data representative of the plurality of said key words liked by said user is interactively created in advance.
